(19) United States
(12) Patent Application Publication
(10) Pub. No.: US 2009/0068898 A1
(43) Pub. Date: Mar. 12, 2009

(54) CONNECTOR FOR MOVABLE STORAGE DEVICE

(75) Inventor: Wang Soo Ryu, Seoul (KR)

Correspondence Address: IPLA P.A., 3580 WILSHIRE BLVD., 17TH FLOOR, LOS ANGELES, CA, 90010, US

(73) Assignee: SKY UMS CO., LTD., Seoul (KR)

(21) Appl. No.: 12/160,288

(22) PCT Filed: Feb. 28, 2007
(86) PCT No.: PCT/KR07/01027

§ 371 Date: Jul. 8, 2008

(30) Foreign Application Priority Data
Mar. 2, 2006 (KR) 10-2006-0019756

(51) Int. Cl. H01R 33/00

(52) U.S. Cl. 439/638

(57) ABSTRACT

Provided is a connector for a movable storage device which can prevent escape of the movable storage device. The connector includes a connection port (315) connected to a movable storage device (330), and a line through which data is exchanged with a car audio using an electrical unit, wherein the connector is inserted and mounted into the car audio to be opened and closed and when the movable storage device is connected to a digital device, the long shaft of the movable storage device is inserted in a vertical direction and the connection state of the movable storage device and the digital device is maintained by the weight of the movable storage device, and when a force from the outside is applied to the connector, the connection port (315) is protruded toward the outside by a predetermined gap in a drawer shape and the connection port (315) provided at an upper end of the connector is exposed so that the connection port (315) can be connected to the movable storage device (330) in a direction perpendicular to the movable storage device (330).

### TECHNICAL FIELD

The present invention relates to a connector structure, and more particularly, to a connector for a movable storage device which can prevent escape of a movable storage device in spite of continuous vibration situations like in a car audio.

### Background Art

In general, cassette tape decks and compact disc (CD) players have been mainly used as music reproducing devices for a car audio. However, due to the limit of sound quality of a cassette tape, date deletion of compact disc, read-only-memory (CD-ROM) and deficiency of facilitation of rewrite, users demands for a movable data storage means which can more conveniently repeat writing and deleting a larger capacity of data and can be easily carried, are increasing. Due to the demands, the development of a semiconductor integration technology and the development of a memory fabrication technology, movable storage devices, such as universal serial bus (USB) storage devices, which can be easily carried, in which the capacity of memory is remarkably increased and which can download and upload data directly with a personal computer (PC) using a USB port etc, and MP3 players have been invented. Currently, movable storage devices and MP3 players have been widely used.

FIG. 1 is a schematic perspective view illustrating connection between a conventional digital device and a conventional movable storage device.

Referring to FIG. 1, a movable storage device 110 is connected to a digital device 120 and performs data upload and download. The long shaft of a main body of the movable storage device 110 is mounted horizontally and is protruded toward the appearance of the digital device 120 such as a car audio. Thus, due to user s carelessness like that a driver touches the movable storage device 110 by hand or foot or drops an object onto the movable storage device 110, there is a problem that the movable storage device 110 may be frequently affected by shock or may frequently and easily escape from the digital device 120.

In particular, when the movable storage device is connected to the car audio in which situations of vibration of more than a predetermined strength occur like in a driving automobile, due to continuous vibration or shock, the movable storage device may escape from the digital device and a user is inconvenient.

### DISCLOSURE OF INVENTION

### Technical Problem

The present invention provides a connector for a movable storage device having an improved structure in which, when the movable storage device is connected to a digital device, the long shaft of the movable storage device is inserted in a vertical direction and the connection state of the movable storage device and the digital device is maintained by the weight of the movable storage device so that undesired escape of the movable storage device can be prevented in spite of continuous vibration.

### Technical Solution

According to an aspect of the present invention, there is provided a connector for a movable storage device, the connector comprising: a connection port connected to the movable storage device; and a line through which data is exchanged with a digital device using an electrical unit, wherein the connector is inserted and mounted into the digital device and can be opened and closed and when the movable storage device is connected to a digital device, the long shaft of the movable storage device is inserted in a vertical direction and the connection state of the movable storage device and the digital device is maintained by the weight of the movable storage device.

According to another aspect of the present invention, there is provided a connector for a movable storage device, the connector comprising: a connection port connected to the movable storage device; and a line through which data is exchanged with a digital device using an electrical unit, wherein the connector is inserted and mounted into the digital device and can be opened and closed and when a force from the outside is applied to the connector, an upper end of the connector is inclined toward the outside in a swing shape by a predetermined angle and the connection port provided at the upper end of the connector is exposed and the movable storage device is inserted in a vertical direction so that the connection state of the movable storage device and the digital device can be maintained by the weight of the movable storage device.

According to another aspect of the present invention, there is provided a connector for a movable storage device, the connector comprising: a connection port connected to the movable storage device; and a line through which data is exchanged with a digital device using an electrical unit, wherein the connector is inserted and mounted into the digital device and can be opened and closed and when a force from the outside is applied to the connector, the connection port is protruded toward the outside by a predetermined gap in a drawer shape and the connection port provided at an upper end of the connector is exposed and is inserted in a direction perpendicular to the movable storage device so that the connection state of the movable storage device and the digital device can be maintained by the weight of the movable storage device.

### Advantageous Effects

In a connector for a movable storage device according to the present invention, an upper end of the connector in which a connection port is provided in a swing or drawer shape is exposed so that, when the long shaft of the movable storage device is connected to a digital device, it is inserted in a vertical direction and the connection state of the movable storage device and the digital device is maintained so that undesired escape of the movable storage device can be prevented in spite of continuous situations like in automobile driving.

### BRIEF DESCRIPTION OF THE DRAWINGS

FIG. 1 is a schematic perspective view illustrating connection between a conventional digital device and a conventional movable storage device.

FIG. 2 is a schematic perspective view illustrating the structure of a connector for a movable storage device according to an embodiment of the present invention.

FIG. 3 is a schematic perspective view illustrating the structure of a connector for a movable storage device according to another embodiment of the present invention.

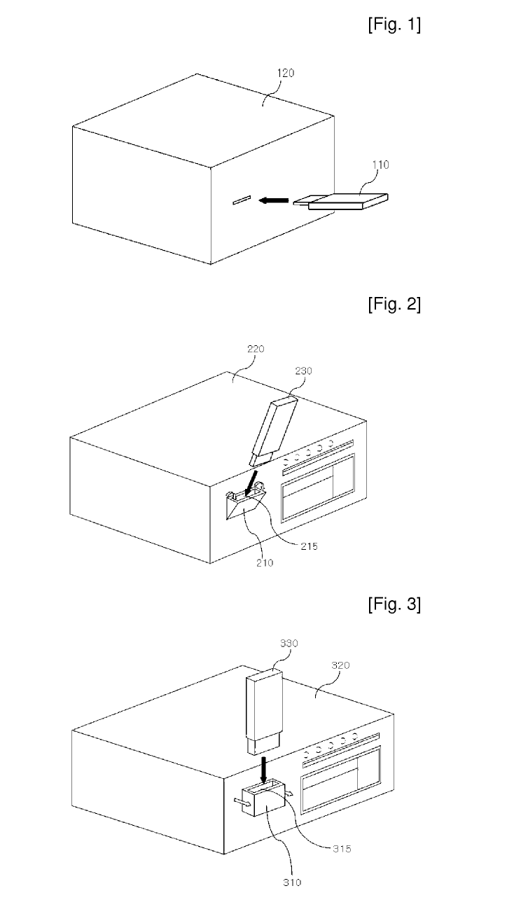

### BEST MODE FOR CARRYING OUT THE INVENTION

The present invention will now be described more fully with reference to the accompanying drawings, in which exemplary embodiments of the invention are shown.

In describing the present invention, when it is determined that a detailed description of related well-known function or configuration may make the key point of the present invention unnecessarily vague, the detailed description will not be repeated. A connector for a movable storage device according to the present invention comprises: a connection port connected to the movable storage device; and a line through which data is exchanged with a digital device using an electrical unit. This is a well-known technology to those of ordinary skill in the art. Thus, a description of elements of the connector is unnecessary to describe the core structure of the present invention and will not be repeated.

FIG. 2 is a schematic perspective view illustrating the structure of a connector for a movable storage device according to an embodiment of the present invention.

Referring to FIG. 2, a connector 210 for a movable storage device is inserted and mounted into a digital device 220 and can be opened and closed. When a force of a predetermined strength from the outside is applied to the connector 210, an upper portion of the connector 210 is inclined toward the outside by a predetermined angle and a connection port 215 is exposed so that the connector 210 can be connected to a movable storage device 230.

In other words, when the connector 210 for a movable storage device is inserted into the digital device 220, when a user presses a front part (a part exposed to the outside of the digital device 220) of the connector 210 for a movable storage device by finger or when the user pulls the front part by hanging a finger tip in a groove formed in the connector 210 for a movable storage device, only an upper end of the connector 210 for a movable storage device is inclined toward the outside in a swing shape, that is, there is no change in a lower end of the connector 210 fixed by a hinge etc. and only the upper end of the connector 210 is inclined toward the outside so that the connection port 215 provided at the upper end of the connector 210 is exposed and the movable storage device 230 can be connected and mounted to the exposed connection port 215.

The upper end of the connector 210 is inclined only by a predetermined angle by a fixing means such as a support. The predetermined angle is a minimum angle at which the connection port 215 is exposed and the movable storage device 230 can be connected to the connection port 215.

The movable storage device 230 may be a universal serial bus (USB) storage and the connection port 215 may be a USB port.

The digital device 220 may be a MP3 car audio or personal computer (PC) and includes all digital devices that can be connected to a movable storage device of the same level as the MP3 car audio or PC, such as DVD players having a MP3 play function or audios.

FIG. 3 is a schematic perspective view illustrating the structure of a connector for a movable storage device according to another embodiment of the present invention.

Referring to FIG. 3, a connector 310 for a movable storage device is inserted and mounted into a digital device 320 and can be opened and closed. When a force of a predetermined strength from the outside is applied to the connector 310, a main body of the connector 310 is protruded toward the outside in a horizontal direction and a connection port 315 provided at an upper end of the connector 310 is exposed so that a movable storage device 330 can be connected to the connection port 315 in a vertical direction.

In other words, when the connector 310 for a movable storage device is inserted into the digital device 320, when a user presses a front part (a part exposed to the outside of the digital device 220) of the connector 310 for a movable storage device by finger or when the user pulls the front part by hanging a finger tip in a groove formed in the connector 310 for a movable storage device, the main body of the connector 310 is protruded toward the outside in a drawer shape and the connection port 315 provided at an upper end of the connector 310 is exposed so that the movable storage device 330 can be connected and mounted to the exposed connection port 315 in a vertical direction.

The main body of the connector 310 is protruded toward the outside only by a pre-determined gap using a fixing means such as a support. The predetermined angle is a minimum angle at which the connection port 315 is exposed and the movable storage device 330 can be connected to the connection port 315 in a vertical direction.

As described previously, the movable storage device 330 may be a universal serial bus (USB) storage and the connection port 315 may be a USB port.

In addition, the digital device 320 may be a MP3 car audio or personal computer (PC) and includes all digital devices that can be connected to a movable storage device of the same level as the MP3 car audio or PC, such as DVD players having a MP3 play function or audios.

As described above, in the connector for a movable storage device according to the present invention, an upper end of the connector in which a connection port is provided in a swing or drawer shape is exposed so that, when the long shaft of the movable storage device is connected to a digital device, it is inserted in a vertical direction and the connection state of the movable storage device and the digital device is maintained so that undesired escape of the movable storage device can be prevented in spite of continuous situations like in automobile driving.

### INDUSTRIAL APPLICABILITY

The connector for a movable storage device according to the present invention can be applied to a car audio.

While this invention has been particularly shown and described with reference to an exemplary embodiment thereof, it will be understood by those skilled in the art that various changes in form and details may be made therein without departing from the spirit and scope of the invention as defined by the appended claims.

1. (canceled)

2. A connector for a movable storage device, the connector comprising:
a connection port to be connected to a movable storage device; and
a line through which data is exchanged with a car audio using an electrical unit, wherein the connector is inserted and mounted into the car audio to be opened and closed when the movable storage device is connected to a digital device, the long shaft of the movable storage device is vertically inserted and the connection state of the movable storage device and the digital device is maintained by the weight of the movable storage device, and when an outer force is applied to the connector, the connection port is outwardly protruded with a predetermined gap in a drawer shape and the connection port provided at an upper end of the connector is exposed so that the connection port can be connected to the movable storage device in a direction perpendicular to the movable storage device.

3. The connector according to claim 2, wherein the connector is pivotally moved with respect to the car audio.

4. The connector according to claim 2, wherein the connector is linearly moved with respect to the car audio.
